(19) United States
(12) Patent Application Publication
(10) Pub. No.: US 2009/0206020 A1
(43) Pub. Date: Aug. 20, 2009

(54) Device for Producing Magnetized Water

(76) Inventors: Seun Cheol Lee, Gyeonggi-Do (KR); Yale Ann, San Dimas, CA (US)

Correspondence Address: PARK LAW FIRM, 3255 WILSHIRE BLVD, SUITE 1110, LOS ANGELES, CA, 90010, US

(21) Appl. No.: 12/371,842

(22) Filed: Feb. 16, 2009

(30) Foreign Application Priority Data
Feb. 15, 2008 (KR) 10-2008-0013765
Mar. 6, 2008 (KR) 10-2008-0020836

(51) Int. Cl. C02F 1/48

(52) U.S. Cl. 210/222

(57) ABSTRACT

Provided is a device for producing magnetized water which can be installed outside a water feed pipe for supplying drinking water, or inside a shower head or water purifier to magnetize the water being supplied into healthful functional water by utilizing characteristics of magnetic ions, so that the magnetized water enhances skin care and prevention and therapeutic effects on skin infections when used to shower, or the magnetized water detoxicates or neutralizes poisonous substance, and is excellent in anti-inflammation effect when used as a drinking water, thereby increasing natural healing force against diseases.

### CROSS-REFERENCE(S) TO RELATED APPLICATIONS

The present invention claims priority of Korean patent application number 10-2008-0020836, filed on Mar. 6, 2008 and 10-2008-0013765, filed on Feb. 15, 2008, which is incorporated by reference in its entirety.

### BACKGROUND OF THE INVENTION

The present invention relates to a device for producing magnetized water; and, more particularly, to a device for producing magnetized water which can be installed outside a water feed pipe for supplying drinking water, or inside a shower head or water purifier to magnetize the water being supplied into healthful functional water by utilizing characteristics of magnetic ions, so that the magnetized water enhances skin care and prevention and therapeutic effects on skin infections when used to shower, or the magnetized water detoxicates or neutralizes poisonous substance, and is excellent in anti-inflammation effect when used as a drinking water, thereby increasing natural healing force against diseases.

As well known, water has a simple molecular structure composed of one oxygen atom being a negative ion and two hydrogen atoms being positive ions covalently bonded each other. Water is found in a liquid state between 0 and 100° C., a solid state at temperatures less than 0° C., and a gaseous state at temperatures higher than 100° C., and its volume increases in a solid and a gaseous state.

It is also a well-known fact that body fluid (both human beings and animals) and plant juice has a hexagonal structure, not the typical water molecular structure, even at room temperature.

In the hexagonal structured magnetized water, however, no bacteria can breathe in oxygen in the water molecules, nor live therein under many restrictions set by magnetic energy of about 0.5 Gauss that is essentially retained in the course of bonding between positive atomic hydrogen ions and negative atomic oxygen ions which are present six times more than in typical water. Although some bacteria may have survived, they cannot propagate and will eventually go extinct.

Therefore, the more magnetized water inside the body, the better. From indirect aspects, human body fluid has natural healing force, excellent in detoxification or neutralization of all kinds of toxins and in suppression of bacterial propagation.

Unfortunately, many people today are exposed to all kinds of environmental environments of polluted water and air and to their byproducts, i.e. low quality air and heavy metals, brought into the body via direct/indirect routes. And people are not always capable of tolerating these with a limited number of white blood cells and a given amount of body fluid only, so a growing number of grown-ups are taken to adult diseases such as high blood pressure, neuralgia, diabetes, etc.

Therefore, there is a need to develop a device for producing magnetized water which can be installed outside a water feed pipe for supplying drinking water, or inside a shower head or water purifier to magnetize the water being supplied into healthful functional water by utilizing characteristics of magnetic ions, so that the magnetized water enhances skin care and prevention or therapeutic effects on skin infections when used to shower, or the magnetized water detoxicates or neutralizes poisonous substance, and is excellent in anti-inflammation effect when used as a drinking water, thereby increasing natural healing force against diseases.

### SUMMARY OF THE INVENTION

It is, therefore, an object of the present invention to provide a device for producing magnetized water using characteristics of magnetic ions, in which neodymium based magnets are stacked in a vertical direction near a drinking water feed pipe in a manner that like poles of the magnets face each other, so that magnetic treatment effects can be increased yet the overall structure of the device may be simplified.

Another object of the present invention is to provide a device for producing magnetized water, in which iron plates for finishing connection of magnets are treated with nano silver, so that anions and far infrared rays are generated to increase magnetic treatment effects.

Still another object of the present invention is to provide a device for producing magnetized water, which can be built in all types of shower heads to magnetize water coming out through them and obtain healthful functional water, so that advantages of the magnetized water in skin care and prevention and therapeutic effects on skin infections can be increased.

Still another object of the present invention is to provide a device for producing magnetized water, which can be built in all types of shower heads and water purifiers to remove impurities and foreign matters, so that pure water can be produced.

Yet another object of the present invention is to provide a device for producing magnetized water, which detoxicates or neutralizes poisonous substance and is excellent in anti-inflammation effect when used as a drinking water, so that natural healing force against diseases can be increased.

In accordance with the present invention, there is provided a device for producing magnetized water that is configured as an externally attached device for producing magnetized water to be installed at outer circumference of a water supply pipe, and as an internally built-in type device for producing magnetized water to be insertedly mounted inside a shower head or a water purifier, so as to magnetize water flowing in the pipe, the shower head, and the water purifier.

Preferably, the externally attached device for producing magnetized water comprises: a body, which is formed into a semi-octagonal shape, which has a hole formed on an oblique face to which a bolt is inserted to connect the body to the outer circumference of a pipe, and which is divided into an upper body having a receptor compartment formed at the center of an upper portion in which a magnet and a finish plate are insertedly mounted, and a lower body having the same structure as the upper body and having a screw thread formed in the hole to which the bolt is inserted to function as a nut; a collection of magnets which are insertedly mounted in the receptor compartment of the body to magnetize a drinking water flowing in the pipe and which combine three magnets in one body with a pole arrangement of N/S, N/S, and N/S; and a finish plate disposed at the top of the magnet, which prevents the magnet from being separated from the body and which is treated with nano silver to generate anions and far infrared rays effective for reinforcing water magnetization performance of the magnet.

Preferably, the internally built-in type device for producing magnetized water is composed of neodymium magnets in “O” shape, “N” poles inside and “S” poles outside, and a cap to prevent the magnets from being eroded by water flowing in a pipe.

Another aspect of the present invention provides an internally built-in type device for producing magnetized water is insertedly mounted inside a handle of a nozzle type shower comprising a head for spouting water and the handle, so that water flowing in a tube is magnetized.

Still another aspect of the present invention provides an internally built-in type device for producing magnetized water, which is insertedly mounted inside a head of a wall-mount type shower comprising an attachment unit for attaching the shower to the surface of wall and the head for spouting water, so that water flowing in a tube is magnetized.

Still another aspect of the present invention provides an internally built-in type device for producing magnetized water, which is insertedly mounted inside a connection unit of a water purifier comprising the connecting unit to which a faucet is connected and a built-in filter for purifying water being supplied through the connecting unit, so that water flowing in a tube is magnetized.

Yet another aspect of the present invention provides an internally built-in type device for producing magnetized water, which is insertedly mounted inside a water supply pipe of a faucet portable water purifier comprising a water purification unit and the water supply pipe for supplying water to the water purification unit, so that water being supplied to the water purifier can be magnetized.

The present invention with the above configuration has the following advantages.

The present invention device for producing magnetized water using characteristics of magnetic ions comprises neodymium based magnets stacked in a vertical direction near a drinking water feed pipe in a manner that like poles of the magnets face each other, so that magnetic treatment effects can be increased yet the overall structure of the device may be simplified.

The present invention device for producing magnetized water comprises iron plates for finishing connection of magnets are treated with nano silver, so that anions and far infrared rays are generated to increase magnetic treatment effects.

The present invention device for producing magnetized water can be built in all types of shower heads to magnetize water coming out through them and obtain healthful functional water, so that advantages of the magnetized water in skin care and prevention and therapeutic effects on skin infections can be increased.

The present invention device for producing magnetized water can be built in all types of shower heads and water purifiers to remove impurities and foreign matters, so that pure water can be produced.

The present invention device for producing magnetized water detoxicates or neutralizes poisonous substance and is excellent in anti-inflammation effect when used as a drinking water, so that natural healing force against diseases can be increased.

The other objectives and advantages of the invention will be understood by the following description and will also be appreciated by the embodiments of the invention more clearly. Further, the objectives and advantages of the invention will readily be seen that they can be realized by the means and its combination specified in the claims.

### BRIEF DESCRIPTION OF THE DRAWINGS

FIG. 1 is an exploded perspective view of an externally attached device for producing magnetized water according to one embodiment of the present invention;

FIG. 2 is a cross-sectional view of an externally attached device for producing magnetized water according to one embodiment of the present invention;

FIG. 3 is a perspective view of an internally built-in type device for producing magnetized water according to one embodiment of the present invention;

FIG. 4 is a cross-sectional view of an internally built-in device type for producing magnetized water according to one embodiment of the present invention;

FIG. 5 is a cross-sectional view showing an implementation example of a device for producing magnetized water according to one embodiment of the present invention.

### DESCRIPTION OF SPECIFIC EMBODIMENTS

Hereinafter, preferred embodiments of the present invention will be set forth in detail with reference to the accompanying drawings so that those skilled in the art can easily carry out the invention.

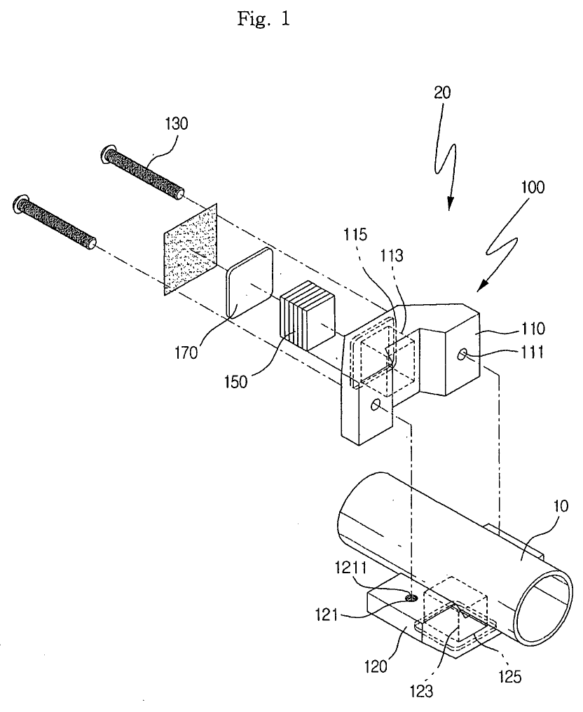

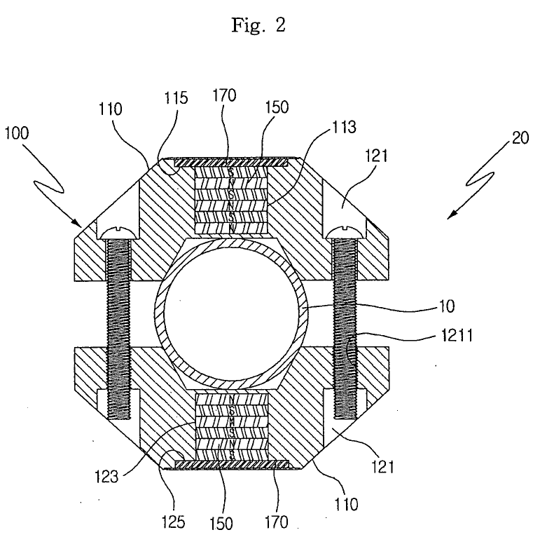

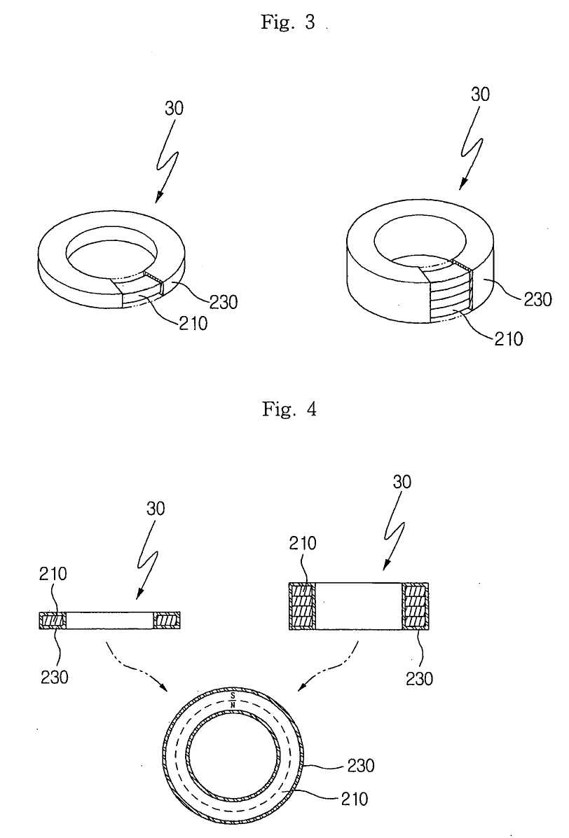

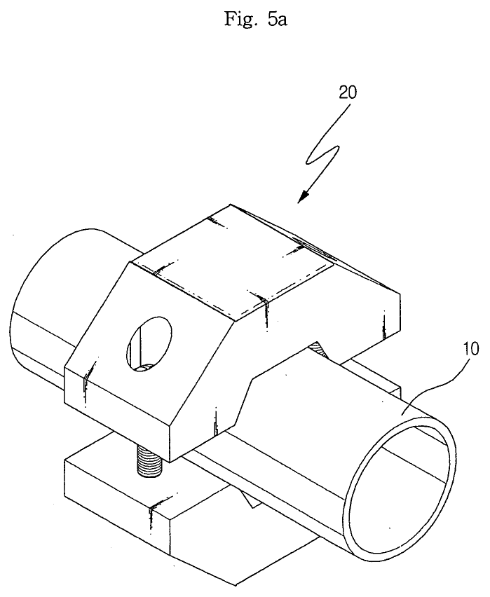

FIG. 1 is an exploded perspective view of an externally attached device for producing magnetized water according to one embodiment of the present invention, FIG. 2 is a cross-sectional view of an externally attached device for producing magnetized water according to one embodiment of the present invention, FIG. 3 is a perspective view of an internally built-in type device for producing magnetized water according to one embodiment of the present invention, and FIG. 4 is a cross-sectional view of an internally built-in device type for producing magnetized water according to one embodiment of the present invention.

A device 1 for producing magnetized water according to a preferred embodiment of the present invention is classified into an externally attached device 20 for producing magnetized water, and an internally built-in type device 30 for producing magnetized water.

The externally attached device 20 for producing magnetized water includes a body 100, magnets 150 insertedly mounted in the body 100 to magnetize water in the pipe 10, and a finish plate 170 to prevent the magnets 150 from separating from the body 100.

The body 100 has a semi-octagonal shape in a separated form of an upper body 110 and a lower body 130.

The upper body 110 has, on its oblique face, a hole 111 to which a bolt 130 is inserted, so that the body 100 can be connected to the outer circumference of the pipe 10.

The upper body 110 also has a receptor compartment 113 at the center of the upper portion, in which the magnets 150 (to be described) are insertedly mounted.

The top of the receptor compartment 113 in which the magnets 150 are insertedly mounted has a step height 115 wider than the receptor compartment 113 to receive the finish plate 170 (to be described).

Similar to the upper body 110, the lower body 120 also has, on its oblique face, a hole 121 to which a bolt 130 is inserted, so that the body 100 can be connected to the outer circumference of the pipe 10. A screw thread 1211 is formed in the hole 121 to function as a nut.

The lower body 120 has a receptor compartment 123 at the center of the upper portion, in which the magnets 150 (to be described) are insertedly mounted.

The top of the receptor compartment 123 in which the magnets 150 are insertedly mounted has a step height 125 wider than the receptor compartment 123 to receive the finish plate 170 (to be described).

The magnets 150 are insertedly mounted in the receptor compartments 113 and 123 of the body 110 to magnetize a drinking water flowing in a pipe.

As shown in FIG. 2, the magnets 150 are composed of three magnets that are combined in one body with a pole arrangement of N/S, N/S, and N/S, so as to increase the magnetization performance on the drinking water flowing in the pipe.

The finish plate 170 is positioned at the top of the magnets 150 to prevent the magnets 150 from being separated from the body 100.

The finish plate 170 is treated with nano silver to be able to generate anions and far infrared rays that are effective for increasing the water magnetization function of the magnets 150.

The internally built-in type device 30 for producing magnetized water is composed of neodymium magnets 210 in “O” shape, “N” poles inside and “S” poles outside, and a cap 230 to prevent the magnets 210 from being eroded by water flowing in the pipe.

The internally built-in type device 30 for producing magnetized water is installed inside a target water supply system, and magnetizes the water being supplied therein by utilizing characteristics of magnetic ions.

Depending on where it is installed, one magnet 210 may be surrounded by the cap 230, or two or more than two magnets 210 may be surrounded by the cap 230.

The operation of the present invention will now be explained with reference to accompanying drawings.

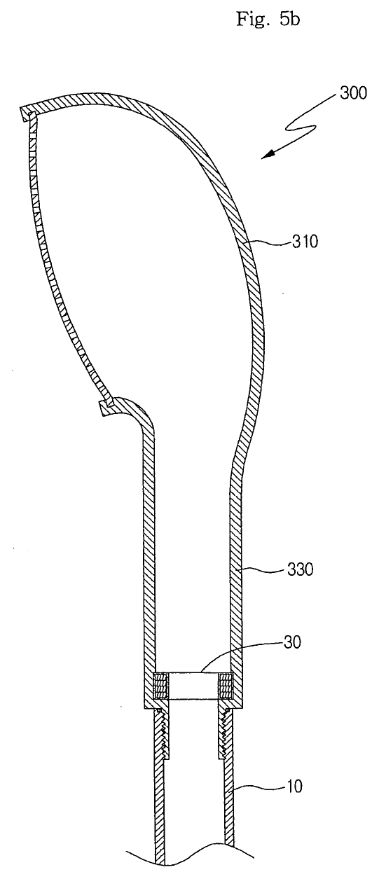

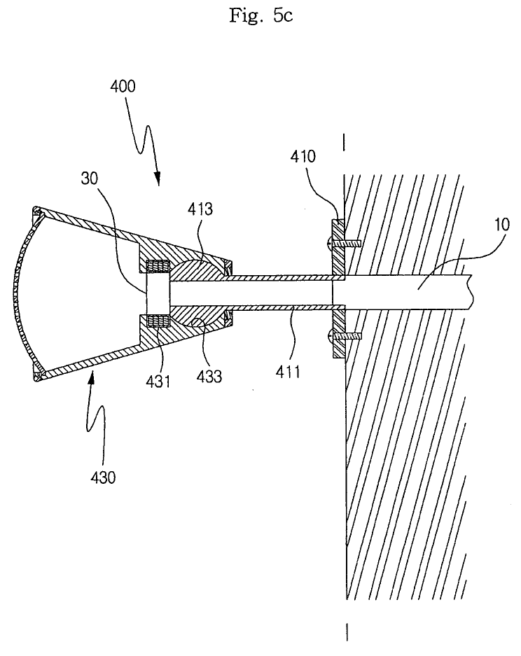

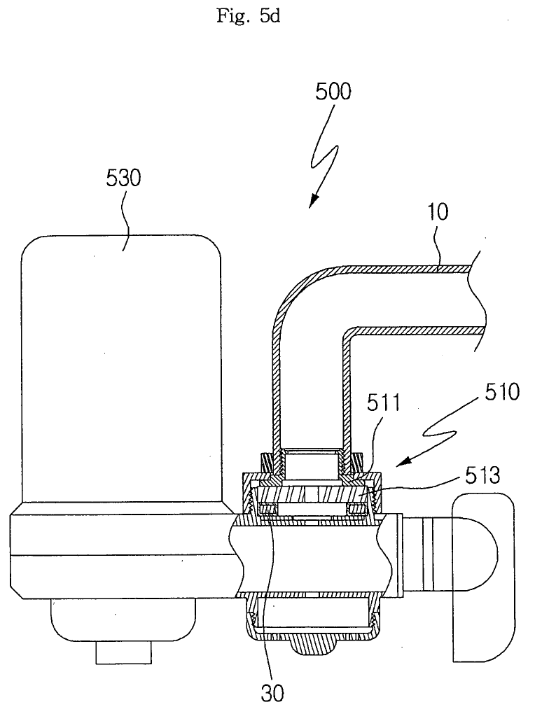

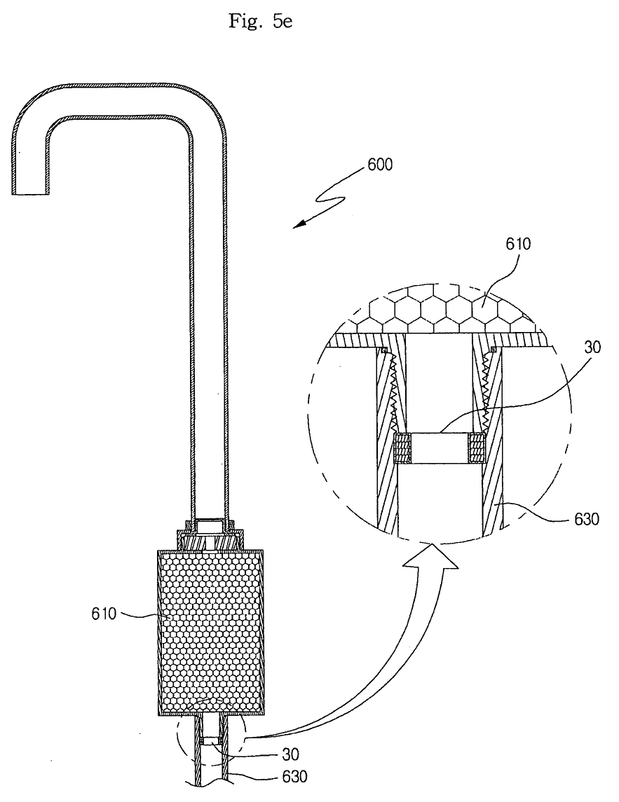

FIG. 5 is a cross0sectional view of an implementation example of the present invention device for producing magnetized water. In particular, FIG. 5(a) is a cross-sectional view of an installation state of an externally attached device for producing magnetized water.

The upper body 110 having the magnets 150 insertedly housed therein is disposed at the top of the pipe 10 used as a water path.

In this state, the lower body 120 is placed under the pipe 10 where the upper body 110 is located.

At this time, the magnets 150 inserted in the upper and lower bodies 110 and 120 are arranged in a manner that like poles face each other.

In this state, the upper body 110 and the lower body 120 are connected by the bolt 130 to be fixed at the outer circumference of the pipe 10.

The body 100 connected to the outer circumference of the pipe 10 causes the magnets 150 to magnetize the drinking water flowing therein.

Here, the finish plate 170 being insertedly mounted outside the magnets and treated with nano silver generates anions and far infrared rays, so that the water magnetization function of the magnets 150 is reinforced.

FIG. 5b is a cross-sectional view of a nozzle type shower with an internally built-in device for producing magnetized water insertedly mounted therein. A nozzle type shower 300 is composed of a head 310 for spouting water, and a handle 330 in which the device 100 for producing magnetized water is inserted mounted.

This internally built-in type device 30 for producing magnetized water is inserted in the handle 330 of the shower 300 to magnetize water flowing in a tube.

FIG. 5c is a cross sectional view of a wall-mount type shower with an internally built-in device for producing magnetized water insertedly mounted therein. A wall-mount type shower 400 is composed of an attachment unit 410 used for attaching the shower to the surface of the wall, and a head 430 for spouting water.

The attachment unit 410 is to attach the shower to the surface of the wall, and has a supply pipe 10 formed at the center to supply water to the shower 400. One end of the supply pipe 10 is a supply member 411 having a globular shaped connection mechanism 413 to supply water to the head 430 and help the head 430 to rotate freely.

The head 430 is connected to the connection mechanism 413 provided to the attachment unit 410 and spouts the supplied water. Inside the head 430 is a receptor compartment 431 in which the internally built-in type device 30 for producing magnetized water is insertedly mounted.

One side of the head 430 is a semi-globular shape seat 433 at which the connection mechanism 413 is seated, so that it can freely rotate along the outer circumference of the globular shaped connection mechanism 413.

The internally built-in type device 30 for producing magnetized water is insertedly mounted in the shower head 430 to magnetize water flowing in a tube.

FIG. 5d is a cross-sectional view of an under sink water purifier with the internally built-in type device for producing magnetized water being insertedly mounted therein.

The under sink water purifier 500 is composed of a connection unit 510 to which a faucet is connected, and a water purification unit 530 having a built-in filter to purify a drinking water supplied through the connection unit 510.

The internally built-in type device 30 for producing magnetized water is insertedly mounted inside the connection unit 510 to which the faucet for supplying the water is connected.

That is, the internally built-in type device 30 for producing magnetized water is insertedly mounted inside the connection unit 510 to which the faucet is connected and which has a connecting member 511 provided with a packing 513 to prevent a water leakage to outside, and the connecting member 511 is connected to the top of the device 30.

Therefore, the internally built-in type device 30 for producing magnetized water magnetizes a drinking water supplied through the faucet.

FIG. 5e is a cross-sectional view of a faucet portable water purifier with the internally built-in type device for producing magnetized water being insertedly mounted therein.

A faucet portable water purifier 600 is composed of a water purification unit 610, and a supply pipe 630 for supplying water to the water purification unit 610.

The internally built-in type device 30 for producing magnetized water is insertedly mounted inside the supply pipe 630 to magnetize water being supplied to the water purifier.

That is, the magnet 210 surrounded by a rubber made cap 230 is insertedly mounted to be compressed inside the supply pipe 630, and the supply pipe 630 is then connected to the water purification unit 610. In this manner, water being supplied to the water purification unit 610 passes through the internally built-in type device 30 for producing magnetized water, and is magnetized.

As explained so far, the present invention device for producing magnetized water can be installed at water supply pipes, all types of shower heads, and water purifiers to magnetize water flowing in the pipe, so that pure, healthful function water free of impurities and foreign matters can be produced. The resulting magnetized water enhances skin care and prevention and therapeutic effects on skin infections. Further, the magnetized water detoxicates or neutralizes poisonous substance, and is excellent in anti-inflammation effect when used as a drinking water, thereby increasing natural healing force against diseases.

While the present invention has been described with respect to the specific embodiments, it will be apparent to those skilled in the art that various changes and modifications may be made without departing from the spirit and scope of the invention as defined in the following claims.

What is claimed is:

1. A device for producing magnetized water that is configured as an externally attached device for producing magnetized water to be installed at outer circumference of a water supply pipe, and as an internally built-in type device for producing magnetized water to be insertedly mounted inside a shower head or a water purifier, so as to magnetize water flowing in the pipe, the shower head, and the water purifier.

2. The device of claim 1, wherein the externally attached device for producing magnetized water comprises:
a body, which is formed into a semi-octagonal shape, which has a hole formed on an oblique face to which a bolt is inserted to connect the body to the outer circumference of a pipe, and which is divided into an upper body having a receptor compartment formed at the center of an upper portion in which a magnet and a finish plate are insertedly mounted, and a lower body having the same structure as the upper body and having a screw thread formed in the hole to which the bolt is inserted to function as a nut;
a collection of magnets which are insertedly mounted in the receptor compartment of the body to magnetize a drinking water flowing in the pipe and which combine three magnets in one body with a pole arrangement of N/S, N/S, and N/S; and
a finish plate disposed at the top of the magnet, which prevents the magnet from being separated from the body and which is treated with nano silver to generate anions and far infrared rays effective for reinforcing water magnetization performance of the magnet.

3. The device of claim 1, wherein the internally built-in type device for producing magnetized water is composed of neodymium magnets in “O” shape, “N” poles inside and “S” poles outside, and a cap to prevent the magnets from being eroded by water flowing in a pipe.

4. The device of claim 3, wherein the internally built-in type device for producing magnetized water is insertedly mounted inside a handle of a nozzle type shower that comprises a head for spouting water and the handle, so that water flowing in a tube is magnetized.

5. The device of claim 3, wherein the internally built-in type device for producing magnetized water is insertedly mounted inside a head of a wall-mount type shower that comprises an attachment unit for attaching the shower to the surface of wall and the head for spouting water, so that water flowing in a tube is magnetized.

6. The device of claim 3, wherein the internally built-in type device for producing magnetized water is insertedly mounted inside a connection unit of a water purifier that comprises the connecting unit to which a faucet is connected and a built-in filter for purifying water being supplied through the connecting unit, so that water flowing in a tube is magnetized.

7. The device of claim 3, wherein the internally built-in type device for producing magnetized water is insertedly mounted inside a water supply pipe of a faucet portable water purifier that comprises a water purification unit and the water supply pipe for supplying water to the water purification unit, so that water being supplied to the water purifier can be magnetized.
